(19) United States
(12) Patent Application Publication
(10) Pub. No.: US 2013/0313829 A1
(43) Pub. Date: Nov. 28, 2013

(54) METHOD OF GENERATING ELECTRICAL POWER FOR A PORT

(71) Applicant: Chuck Weller, Brookings, OR (US)

(72) Inventor: Chuck Weller, Brookings, OR (US)

(21) Appl. No.: 13/960,635

(22) Filed: Aug. 6, 2013

Related U.S. Application Data
(63) Continuation of application No. 13/368,459, filed on Feb. 8, 2012.
(60) Provisional application No. 61/440,798, filed on Feb. 8, 2011.

(51) Int. Cl. F03B 13/12

(52) U.S. Cl. CPC F03B 13/12
USPC 290/53

(57) ABSTRACT

A method for generating electrical power for a port. The method includes providing a power generator, where the power generator is secured to a structure within a port and converts energy within a body of water to electrical power. The method also includes providing a power storage, where the power storage is configured to receive the electrical power from the power generator and store the electrical power for future use. The method further includes a power transfer, where the power transfer is configured to direct the electrical power from the power storage to the location of use within the port.

### CROSS-REFERENCE TO RELATED APPLICATIONS

This application is a continuation of, and claims the benefit of and priority to, U.S. patent application Ser. No. 13/368,459 filed on Feb. 8, 2012, which application is incorporated herein by reference in its entirety.

U.S. patent application Ser. No. 13/368,459 claims the benefit of and priority to U.S. Provisional Patent Application Ser. No. 61/440,798 filed on Feb. 8, 2011, which application is incorporated herein by reference in its entirety.

### BACKGROUND OF THE INVENTION

The natural and cyclical rise and fall of sea levels due to tidal processes represents an immense source of energy. Harnessing even a small portion of tidal energy would provide many benefits to coastal communities, the environment, and to consumers of electricity. Unlike solar power or wind power, which are limited by their variable intensity and intermittent availability, tidal power involves a relatively constant amount of energy, and its availability is highly predictable. Thus, tidal power has great potential for being utilized as an environmentally conscious or “green” energy source by humans.

Known tidal power generation apparatuses are not entirely satisfactory for the range of applications in which they are employed. For example, existing tidal power generation apparatuses require unsightly and expensive barrages, embankments, jetties, or sluices. In addition, conventional tidal power generation apparatuses increase sediment and pollution accumulation in and around the body of water in which they are located. Moreover, known tidal power generation apparatuses pose threats to fauna and flora in and around the body of water in which they are located, such as by creating pollution or changing the temperature, turbidity, or chemical makeup of the surrounding water.

A significant disadvantage of conventional tidal power generation apparatuses is the threat to navigation they pose. Existing tidal apparatuses are often large mechanical devices deployed in open water beneath the surface and out of view of approaching watercraft. These devices may be constructed on or near the water surface in navigable or unnavigable waters, such waters reserved for swimming, scuba diving, or operating small, personal watercraft, including small boats, floatation devices, jet skis and the like. Ships, personal watercraft, and people can easily collide and become entangled with such hidden tidal apparatuses despite efforts to provide notice of the location of the apparatuses. Even when navigation aids to locate existing tidal apparatuses are passably effective, the need to deploy and maintain navigation aids, which are often complex, expensive, and prone to malfunction, represents a problem with conventional tidal power generation units described in patent documents, academic journals, or that are otherwise known in practice.

Thus, there exists a need for tidal power generation apparatuses that improve upon and advance the design of known tidal power generation apparatuses. Examples of new and useful tidal power generation apparatuses relevant to the needs existing in the field are discussed below.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a method for generating electrical power for a port. The method includes providing a power generator, where the power generator is secured to a structure within a port and converts energy within a body of water to electrical power. The method also includes providing a power storage, where the power storage is configured to receive the electrical power from the power generator and store the electrical power for future use. The method further includes a power transfer, where the power transfer is configured to direct the electrical power from the power storage to the location of use within the port.

Another example embodiment includes a method for generating electrical power for a port. The method includes providing a power generator. The power generator is secured to a piling. The power generator is also configured to convert energy within a body of water to electrical power. The method also includes providing a power storage, where the power storage is configured to receive the electrical power from the power generator and store the electrical power for future use and produce a stable power output. The method further includes providing a power transfer, where the power transfer is configured to direct the stable power output from the power storage to the location of use.

Another example embodiment includes a method for generating electrical power for a port. The method includes providing a power generator. The power generator is secured to a piling. The power generator is also configured to convert energy within a body of water to electrical power. The method also includes providing a power storage, where the power storage is configured to receive the electrical power from the power generator and store the electrical power for future use and produce a stable power output. The method further includes providing a power transfer, where the power transfer is configured to direct the stable power output from the power storage to the location of use. The power transfer is configured to prioritize the power output to external devices in need of electrical power. The power transfer is also configured to direct the electrical power to the location of use based on the priority order. The power transfer is further configured to direct excess power to an external power grid.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a block diagram illustrating an example of a power system;

FIG. 2 illustrates an example of a power generation system;

FIG. 3 illustrates an alternative power generation system;

FIG. 4 illustrates an alternative power generation system; and

FIG. 5 illustrates an alternative power generation system.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

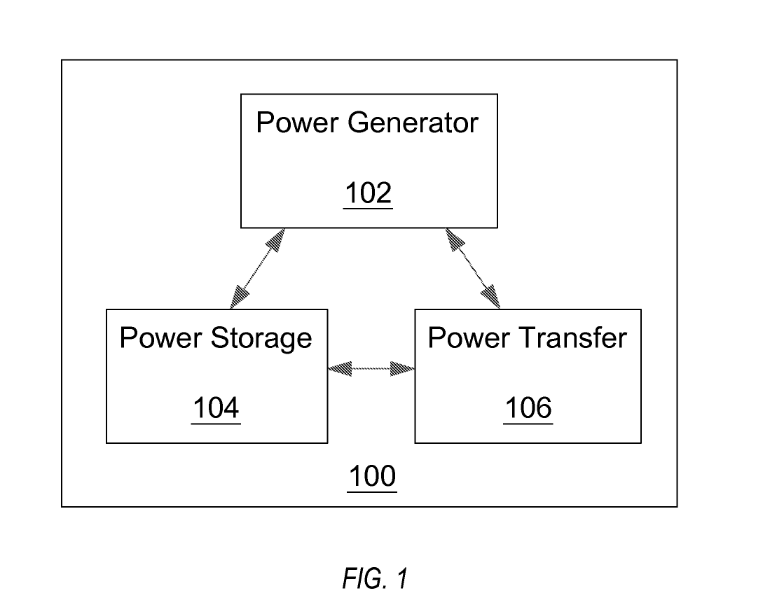

FIG. 1 is a block diagram illustrating an example of a power system 100. In at least one implementation, the power system 100 can be used to generate power for a local area. In particular, the system 100 can be used to power a dock, a marina, a port, a harbor, location indicators, power supplies for boats or other mechanical devices or any other devices or systems near the system 100. A marina is a dock or basin with moorings and supplies for yachts and small boats. A port is a location on a coast or shore containing one or more harbors where ships can dock and transfer people or cargo to or from land. I.e., a marina is a port that only accommodates smaller ships. Additionally or alternatively, the system 100 can produce excess electrical power that can be exported on a power grid.

FIG. 1 shows that the system 100 can include a power generator 102. In at least one implementation, the power generator 102 is configured to convert power from the ocean into electrical energy. For example, the power generator 102 can convert tidal energy, wave energy, thermal energy, ocean currents, or any other energy source within the ocean to electrical power. In particular, the choice of ocean energy to use can depend on the local area. For example, in a relatively sheltered harbor with large tidal changes but low waves, the power generator 102 can convert tidal energy to electrical power. In contrast, in open areas with higher waves but smaller tidal changes the power generator 102 can convert wave energy to electrical power.

FIG. 1 also shows that the system 100 can include power storage 104. In at least one implementation, the power storage 104 is configured to store excess power created by the power generator 102 for future use. For example, the power generator 102 can generate power at times that are not peak energy usage and the power storage 104 can store the generated electrical power for use during peak energy usage. Additionally or alternatively, the power storage 104 can “smooth” the electrical output. That is, if the power generator 102 alternates between cycles of high power production and low energy production, the power storage 104 can output a more constant electrical power supply.

FIG. 1 further shows that the system 100 can include a power transfer 106. In at least one implementation, the power transfer 106 can be used to direct the power to the desired location. For example, the power transfer 106 can direct the electrical power output by the power generator 102 and/or the power storage 104 to dock operations before the power is consumed elsewhere. I.e., the power transfer 106 can allocate the power according to a priority list. Additionally or alternatively, the power transfer 106 can direct electrical power to the local electrical grid if excess electrical power is produced.

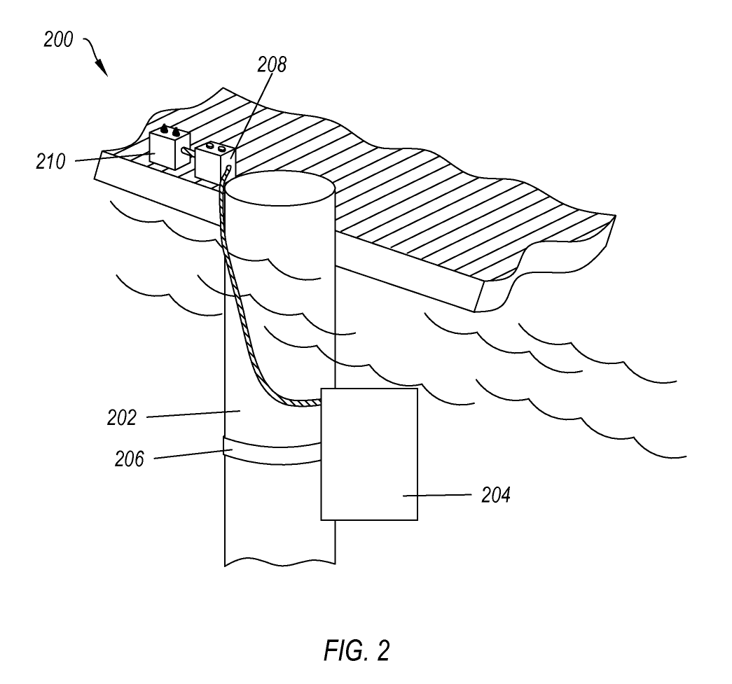

FIG. 2 illustrates an example of a power generation system 200. In at least one implementation, the power generation system 200 can be used to power a port. For example, the power generation system 200 can be used to provide power to lights, outlets, pumps or other devices present in a port. One of skill in the art will appreciate that the power generation system 200 can be used to supply all of the required electrical power, a portion thereof, or excess electrical power, as desired.

FIG. 2 shows that the power generation system 200 can include a piling 202. In at least one implementation, the piling 202 can include a piling supporting an existing dock, home platform or other structure. I.e., the piling 202 can be an existing support structure currently in use supporting an external system in a body of water. The piling can be made of wood, metal, stone or any other suitable material. For example, the piling can include a wooden, metal or concrete post which is driven into the floor of the body of water and extends above the highest expected tide.

FIG. 2 shows that the power generation system 200 can include a power generator 204. In at least one implementation, the power generator 204 can be used to convert energy within the body of water into electrical power. For example, the power generator 204 can be used to convert tidal energy, wave energy, thermal energy, water currents, or any other energy source within the body of water to electrical power.

For example, the power generator 204 can include a tidal generator. Tidal energy is extracted from the relative motion of large bodies of water. Periodic changes of water levels, and associated tidal currents, are due to the gravitational attraction of the Sun and Moon on both the earth and the large bodies of water. Magnitude of the tide at a location is the result of the changing positions of the Moon and Sun relative to the Earth, the effects of Earth rotation, and the local geography of the sea floor and coastlines. Because the Earth's tides are ultimately due to gravitational interaction with the Moon and Sun and the Earth's rotation, tidal power is classified as a renewable energy resource.

A tidal generator uses this phenomenon to generate electricity. Greater tidal variation or tidal current velocities can dramatically increase the potential for tidal electricity generation. For example, the tidal generator can be driven up and down by tidal energy and capture the tidal energy. Additionally or alternatively, several tidal generators may be connected to one another to capture a greater amount of tidal energy from the tide ebbing and flowing past the tidal generators.

In particular, tides include large amounts of force. This means that a buoyant object, regardless of its mass, will rise and fall with the tide. Although this movement may not occur over a long distance the potential force is quite large. Because of this, even small movements can be converted into large amounts of electrical power. For example, gear boxes can translate the small distance to high numbers of rotations, which can, in turn, be used to produce electrical, mechanical or other power output.

Additionally or alternatively, the power generator 204 can include a wave power generator. Waves include masses of water created by one or more energy sources. For example, surface waves may be a result of wind acting on the surface water either locally or continued over long distances. These waves cause the water in the local area to move vertically as the wave is transmitted laterally. Alternatively, waves may be caused by ocean currents or thermal activity below the surface.

A wave power generator may include a linear motion electric power generator which uses the vertical or lateral motion of waves, ocean currents or any other motion to produce electrical power. In a linear motion electric power generator a moving magnet is confined so that it can move with bi-directional linear, or approximately linear, motion through each of at least two coils. The coils are spaced apart from each other and connected electrically so that current produced in a first coil as a result of movement of the moving magnet is substantially in phase with current produced in the second coil.

Additionally or alternatively, the power generator 204 may include one or more turbines. A turbine is a rotary engine that extracts energy from a fluid flow and converts it into useful work. The simplest turbines have one moving part, a rotor assembly, which is a shaft or drum with blades attached. Moving fluid acts on the blades, or the blades react to the flow, so that they move and impart rotational energy to the rotor. Early turbine examples are windmills and water wheels. Water turbines usually have a casing around the blades that contains and controls the working fluid.

Additionally or alternatively, the power generator 204 can include one or more thermoelectric generators. TEGs are made from thermoelectric modules which are solid-state integrated circuits that employ three established thermoelectric effects known as the Peltier, Seebeck and Thomson effects. It is the Seebeck effect that is responsible for electrical power generation. Their construction consists of pairs of p-type and n-type semiconductor materials forming a thermocouple. These thermocouples are then connected electrically forming an array of multiple thermocouples (thermopile). They are then sandwiched between two thin ceramic wafers. In the presence of a temperature gradient (a system where the temperature varies in two areas) the device then generates electricity.

FIG. 2 also shows that the power generation system 200 can include an attachment 206. In at least one implementation, the attachment 206 can be used to attach the power generator 204 to the piling 202. The attachment 206 may be adjustable to attach power generator 204 to already existing pilings 202 of varying dimensions and at varying heights. For example, the attachment 206 may be an elastic type material, a rubber material, nylon ribbon or a metal band that wraps around piling 202 and is capable of tightening. Tightening may be accomplished by ratcheting, using a screw that tightens the material as the screw is tightened, or other known methods. Additionally or alternatively, the attachment 206 may include mounting holes and may be fixed directly to piling 202 using screws, nails, or other known fastening means. The attachment 206 may be located below the water line at the water line or above the water line, as desired.

FIG. 2 further shows that the power generation system 200 can include power storage 208. In at least one implementation, the power storage 208 receives the electrical power generated by the power generator 204. The electrical power is then stored in the power storage 208 until it is needed. Power storage 208 may be any suitable energy storage device such as an electrochemical device (batteries, flow batteries, fuel cells, etc.), mechanical devices (hydraulics, compressed air, etc.), an electrical device (capacitor, super capacitor, superconducting magnetic energy storage (SMES)) or some combination thereof. Of course, other storage methods are envisioned such as chemical, biological, mechanical, and thermal energy storage methods. Any suitable power storage 208 now known or later developed may be utilized.

FIG. 2 additionally shows that the power generation system 200 can include a power transfer 210. In at least one implementation, the power transfer 210 can be electrically connected to the power storage 208 and/or the power generator 204. For example, power transfer 210 may be electrically connected to a dock circuit to provide power for boats in nearby slips or to power other marina operations, as described above.

Additionally or alternatively, power transfer 210 may be used to send electricity back into an electrical grid using conventional and/or later converters and then sold to local power companies at a profit. Grid energy storage may allow excess electricity to be sent over the electricity transmission grid to temporary electricity storage sites that become energy producers when electricity demand is greater. Grid energy storage is particularly important in matching supply and demand over a 24 hour period of time.

Additionally or alternatively, the power transfer 210 may include a manual device for selectively choosing where to direct power. For example, the power transfer 210 may include a logic device with an algorithm for determining how best to transfer power based on power needs. For example, the logic device may direct power to boats in each slip during peak usage hours and then during less demanding hours direct power back to the grid. Additionally or alternatively, power may be directed based on power pricing rather than power needs to maximize profit.

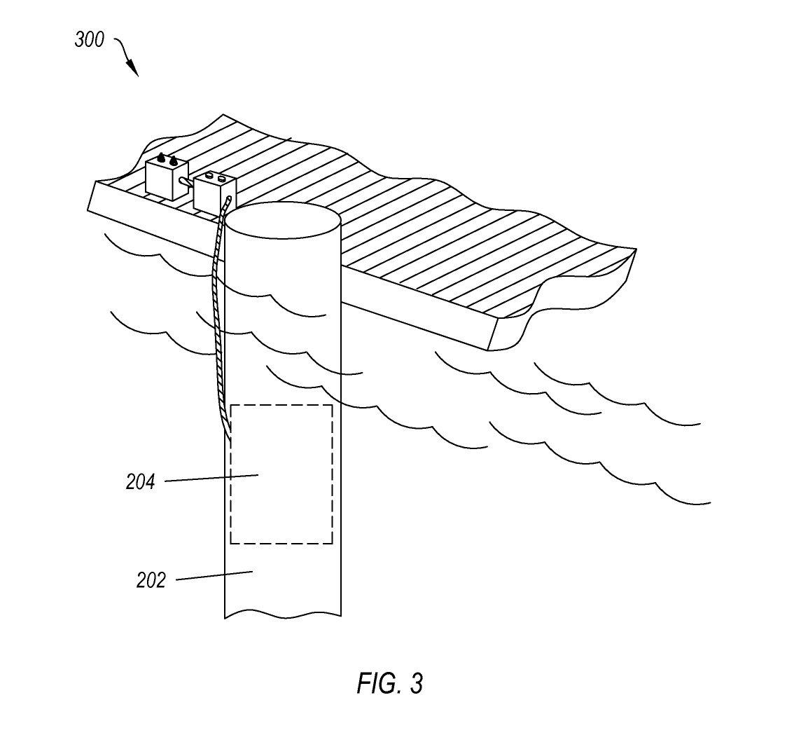

FIG. 3 illustrates an alternative power generation system 300. In at least one implementation, the power generation system 300 can be installed during the construction of a dock. I.e., the power generation system 300 can be more completely integrated with the dock. Additionally or alternatively, the power generation system 300 can be more robust. I.e., the power generation system 300 can be less likely to sustain damage from external sources, such as ships or floating debris.

FIG. 3 shows that the power generator 204 can be located internally relative to the piling 202. I.e., the piling 202 can include a structure with a hollow center. For example, the piling 202 can include a metal cylinder which allows water to enter the internal portion of the piling 202. An attachment can fix the position of the power generator 204 relative to the piling 202 in a desired direction. For example, the attachment can allow the power generator 204 to move vertically relative to the piling 202 but prevent horizontal motion of the power generator 206 relative to the piling.

In at least one implementation, the piling 202 can be used to constrain the flow of the water. For example, as the tide rises, water can enter the piling freely. When the tide lowers, the water can be constrained to exit the piling 202 through a desired path. The path can include a turbine or other device which converts the motion of the water into electrical energy.

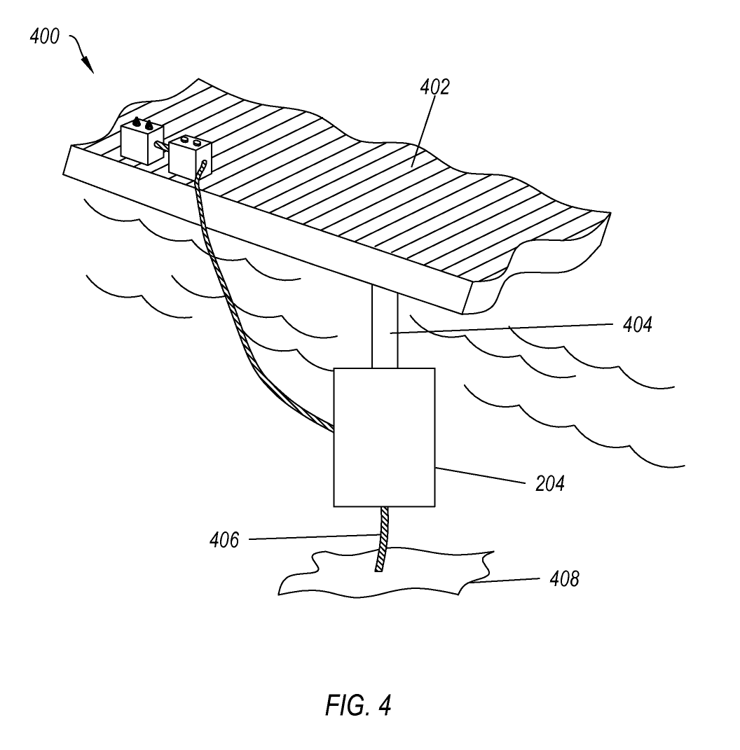

FIG. 4 illustrates an alternative power generation system 400. In at least one implementation, the power generation system 400 can be used in areas without pilings or which lack a direct attachment to pilings. I.e., the power generation system 400 can be used with systems that are free floating, or that rest on the surface of the water rather than being supported on the sea floor or other foundation. The position of the free floating position can be held stable by cables, anchors, pilings or any other system which allows for vertical movement but prevents horizontal movement. For example, the free floating system can include a floating dock, ship or any other system which is designed to remain on the surface of the water.

FIG. 4 shows that the power generation system 400 can include a floating dock 402 or other floating structure. Dock 402 may be a floating dock with buoyancy sufficient to remain afloat on the water while supporting persons or objects on the dock. As the tide rises and falls between high and low tide and as waves produce vertical motion, the dock 402 may correspondingly raise and lower.

FIG. 4 also shows that the power generation system 400 can include a dock attachment 404. In at least one implementation, the dock attachment 404 attaches the power generator 204 to the dock 402. The dock attachment 404 may include mounting holes and may be fixed directly to dock 402 using screws, nails, or other known fastening means. In some examples, the dock attachment 404 does not physically attach to the dock, but instead is supported by the dock in a manner akin to the forks of a forklift.

FIG. 4 further shows that the power generation system 400 can include a second attachment 406. In at least one implementation, the second attachment 406 can connect the power generator 204 to a surface 408 below the water. For example, the second attachment 406 can connect the power generator 204 to the floor of the body of water, to a support structure such as a piling or anchor or any other desired external structure which maintains a fixed position.

Because power generator 204 is fixed to both the surface 408 and dock 402, the raising and lowering of dock 402 causes power generator 204 to alternate between states of tension (pulling), compression (pushing), and/or torsion (twisting). Power generator 204 is configured to convert the energy that causes tension, compression, and/or torsion between the dock 402 and the surface 408 into useable energy using the methods described above.

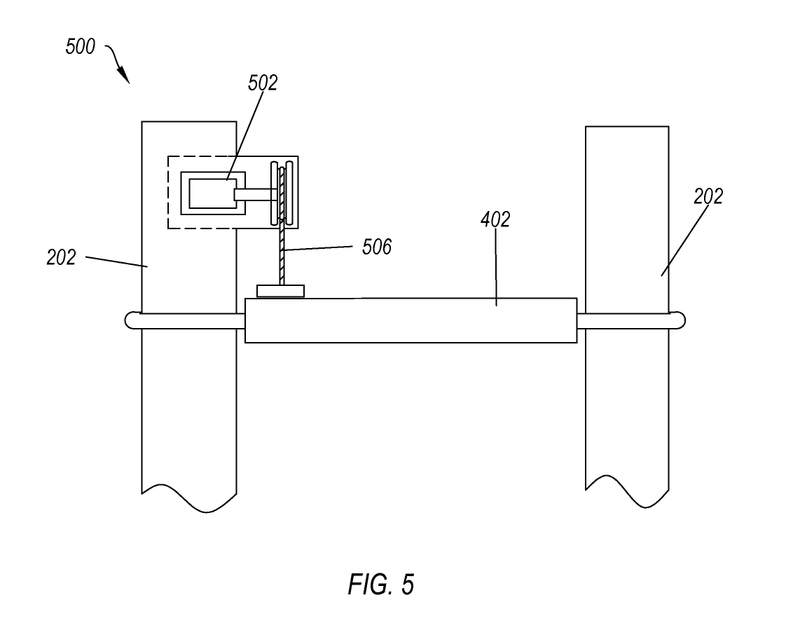

FIG. 5 illustrates an alternative power generation system 500. In at least one implementation, the power generation system 500 can convert vertical motion of the dock 402 for the production of energy. I.e., the power generation system 500 can be used when the dock 402 is experiencing vertical motion relative to a nearby structure, such as a piling 202.

FIG. 5 shows that the system 500 can include a gear box 502. In at least one implementation, the gear box 502 uses gears and gear trains to provide speed and torque conversions from a rotating power source to another device or vice versa. I.e., the energy from the water can be used to cause rotation in the gear box 502, which is then used to generate electrical power. One of skill in the art will appreciate that the gear box 502 can be located above or below the dock 402.

FIG. 5 also shows that the system 500 can include a spool 504. In at least one implementation, the spool 504 is configured to rotate based on movement of the dock 402. I.e., as the dock 402 moves up and down, the spool 504 is rotated, as described below. The rotation of the spool 504 is then transferred to the gear box 502 where it can be used to generate electrical power.

In particular, the gear box 502 can convert the rotation of the spool 504 into a higher number of rotations. That is, the tidal forces causing rotation of the spool 504 may be smaller in distance, but result from an extremely large force. I.e., the tidal forces consistently move the spool 504 in the desired direction of rotation with a high amount of force. Because the amount of force is high, the gear box 502 can transform this rotation into a higher number of rotations, each with less torque that the rotation of the spool 504, which is then used to produce electrical energy.

FIG. 5 further shows that the system 500 can include a cable 506. In at least one implementation, the cable 506 is connected to both the spool 504 and the dock 402. The spool 504 can be biased to keep the cable 506 taut. For example, the spool 504 can include a spring that is under tension and tends to rotate the spool such that the cable 506 is wound about the spool. Thus, as the dock 402 moves a first direction, the spool 504 is rotated as the cable 506 unwinds. In contrast, as the dock 402 moves opposite the first direction, the spool 504 is rotated an opposite direction as the cable 506 is wound on the spool 504 by the spring. Thus, vertical motion is converted into rotational motion.

One of skill in the art will appreciate that the spool 504 and the cable 506 can be replaced by alternative systems. For example, the system 500 can include a rack and pinion. A rack and pinion is a type of linear actuator that comprises a pair of gears which convert rotational motion into linear motion. A circular gear called “the pinion” engages teeth on a linear “gear” bar called “the rack”; rotational motion applied to the pinion causes the rack to move, thereby translating the rotational motion of the pinion into the linear motion of the rack.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for generating electrical power for a port, the method comprising:
providing a power generator, wherein the power generator:
is secured to a structure within a port; and
converts energy within a body of water to electrical power;
providing a power storage, wherein the power storage is configured to receive the electrical power from the power generator and store the electrical power for future use; and
providing a power transfer, wherein the power transfer is configured to direct the electrical power from the power storage to the location of use within the port.

2. The method of claim 1, wherein the power generator includes a tidal power generator.

3. The method of claim 1, wherein the power generator includes a wave power generator.

4. The method of claim 1, wherein the power generator includes a thermoelectric generator.

5. The method of claim 1, wherein the power generator includes a linear motion electric power generator.

6. The method of claim 1 further comprising:
securing the power generator to a piling.

7. The method of claim 1 further comprising:
securing the power generator to a dock.

8. The method of claim 7 further comprising:
securing a second portion of the power generator to a surface below the water.

9. The method of claim 7 further comprising:
securing a second portion of the power generator to a surface above the water.

10. The method of claim 1, wherein the power storage includes a battery.

11. The method of claim 1, wherein the power transfer is configured to transfer the electrical power to one or more nearby boats.

12. A method for generating electrical power for a port, the method comprising:
providing a power generator, wherein the power generator is:
secured to a piling; and
configured to convert energy within a body of water to electrical power;
providing a power storage, wherein the power storage is configured to:
receive the electrical power from the power generator and store the electrical power for future use; and
produce a stable power output; and
providing a power transfer, wherein the power transfer is configured to direct the stable power output from the power storage to the location of use.

13. The method of claim 12, wherein the power generator is attached to an external surface of the piling.

14. The method of claim 12, wherein the power generator is attached to an interior surface of the piling.

15. The method of claim 14, wherein the interior surface of the piling constrains the flow of the water.

16. A method for generating electrical power for a port, the method comprising:
providing a power generator, wherein the power generator is:
secured to a piling; and
configured to convert energy within a body of water to electrical power;
providing a power storage, wherein the power storage is configured to:
receive the electrical power from the power generator and store the electrical power for future use; and
produce a stable power output; and
providing a power transfer, wherein the power transfer is configured to:
prioritize the power output to external devices in need of electrical power;
direct the stable power output from the power storage to the location of use based on the priority order; and
direct excess power to an external power grid.

17. The method of claim 16, wherein the power generator is attached at the water line.

18. The method of claim 16, wherein the power generator is attached above the water line.

19. The method of claim 16, wherein the power generator is attached below the water line.

20. The method of claim 16, wherein the power generator includes:
a spool;
a spring, wherein the spring biases the spool to rotate in a first direction;
a cable, wherein the cable
is attached to the spool; and
is attached to a nearby dock, wherein the dock is capable of rising and falling with the motion of the water;
wherein motion of the dock away from the spool causes the spool to rotate in a second direction, wherein the second direction is opposite the first direction;
wherein motion of the dock toward the spool allows the spring to rotate the spool in the first direction; and
a generator, wherein the generator is configured to covert the rotation of the spool into electrical power.
